(19) United States
(12) Patent Application Publication
(10) Pub. No.: US 2009/0077774 A1
(43) Pub. Date: Mar. 26, 2009

(54) Slide fastener device having warning device

(76) Inventors: Chi Ju Lee, Changhua (TW); Chi Feng Feng, Changhua (TW); Leo Lin, Changhua (TW)

Correspondence Address: CHARLES E. BAXLEY, ESQUIRE, 90 JOHN STREET, SUITE 309, NEW YORK, NY, 10038, US

(21) Appl. No.: 11/903,545

(22) Filed: Sep. 21, 2007

(51) Int. Cl. A44B 19/24; G08B 21/18

(52) U.S. Cl. 24/381; 340/686.1

(57) ABSTRACT

A fastener device includes two fastening elements, one or more slider members slidably engaged onto the fastening elements for securing the fastening elements together, and a warning device having a detecting device which may include two detecting members attached to either of the slider members or a support member and selectively engageable with other, and a signal generating device coupled to the detecting device for generating a warning signal when the detecting members have not been contacted with each other and for preventing the fastener device from being opened by unauthorized persons.

### BACKGROUND OF THE INVENTION

1. Field of the Invention

The present invention relates to a zipper or slide fastener device, and more particularly to a zipper or slide fastener device including a warning device for generating a warning signal and for indicating that the fastener device has not been suitably locked or buckled in place and for preventing the fastener device from being opened by unauthorized persons.

2. Description of the Prior Art

Typical zippers or slide fastener devices comprise one or more slider members slidably attached or engaged onto two fastening elements for openably securing the fastening elements together and for openably closing two housing members together.

For example, U.S. Pat. No. 6,105,763 to Saetia, U.S. Pat. No. 6,179,101 to Lin, and U.S. Pat. No. 6,196,366 to Lin disclose three of the typical suitcases or carrying cases each also comprising a typical zipper or slide fastener device including two fastening elements, and one or more slider members slidably attached or engaged onto the fastening elements for openably securing the fastening elements together and for openably closing two side panels or housing members together.

However, the typical zipper or slide fastener devices have no warning devices for generating warning signals and for indicating that the fastener devices have not been suitably locked or buckled in place such that the fastener devices may be easily opened by unauthorized persons.

The present invention has arisen to mitigate and/or obviate the afore-described disadvantages of the conventional slide fastener devices.

### SUMMARY OF THE INVENTION

The primary objective of the present invention is to provide a slide fastener device including a warning device for generating a warning signal and for indicating that the fastener device has not been suitably locked or buckled in place and for preventing the fastener device from being opened by unauthorized persons.

In accordance with one aspect of the invention, there is provided a fastener device comprising two fastening elements, a slider member slidably engaged onto the fastening elements for securing the fastening elements together, and a warning device including a detecting device having a first detecting member attached to the slider member, and a second detecting member for selectively engaging with the first detecting member, and a signal generating device coupled to the detecting device for generating a warning signal when the first and the second detecting members have not been contacted with each other.

The slider member includes a manual operating tab for operating the slider member, and either of the first or the second detecting member is attached to the tab; or either of the first or the second detecting member is attached to a support member.

The support member may be another slider member. The warning device includes a power circuit coupled to the detecting device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view of a slide fastener device in accordance with the present invention;

FIG. 2 is a partial plan schematic view similar to FIG. 1, illustrating the operation of the slide fastener device;

FIG. 3 is a block diagram illustrating the electric parts of the slide fastener device;

FIG. 4 is a perspective view illustrating the other arrangement of the slide fastener device; and

FIG. 5 is another perspective view similar to FIG. 4, illustrating the operation of the slide fastener device as shown in FIG. 4.

### DETAILED DESCRIPTION OF THE PREFERRED EMBODIMENT

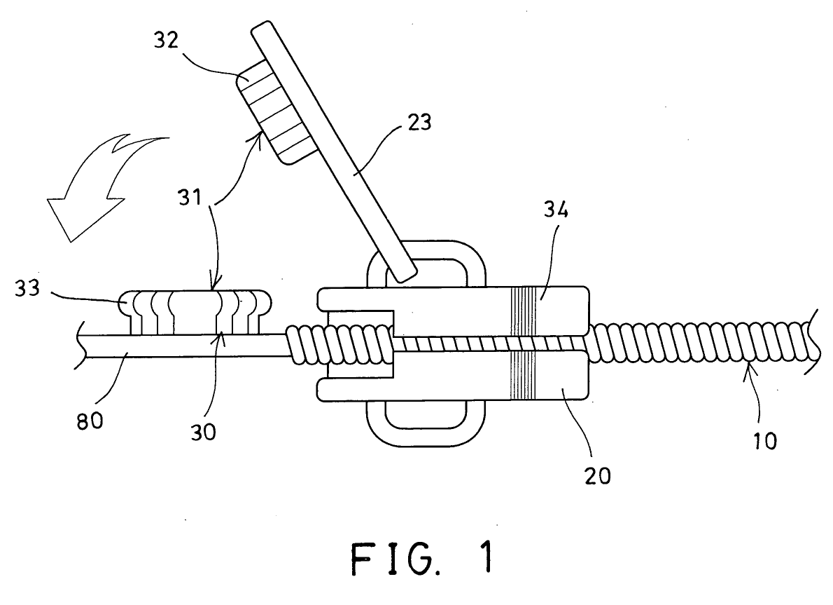

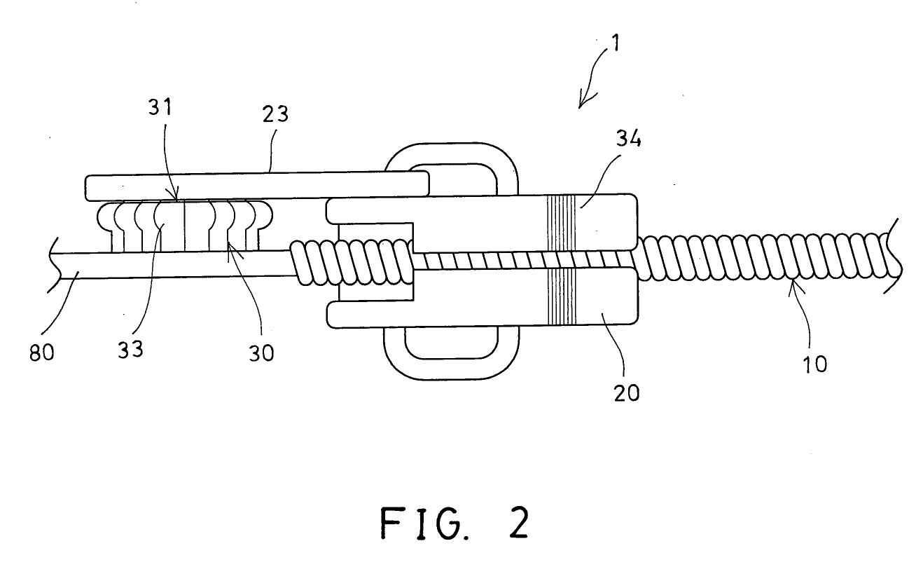

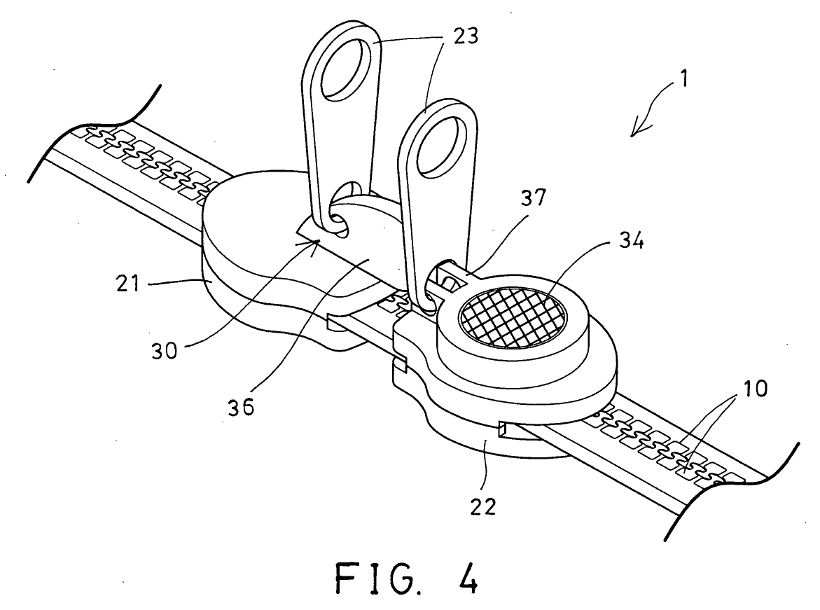

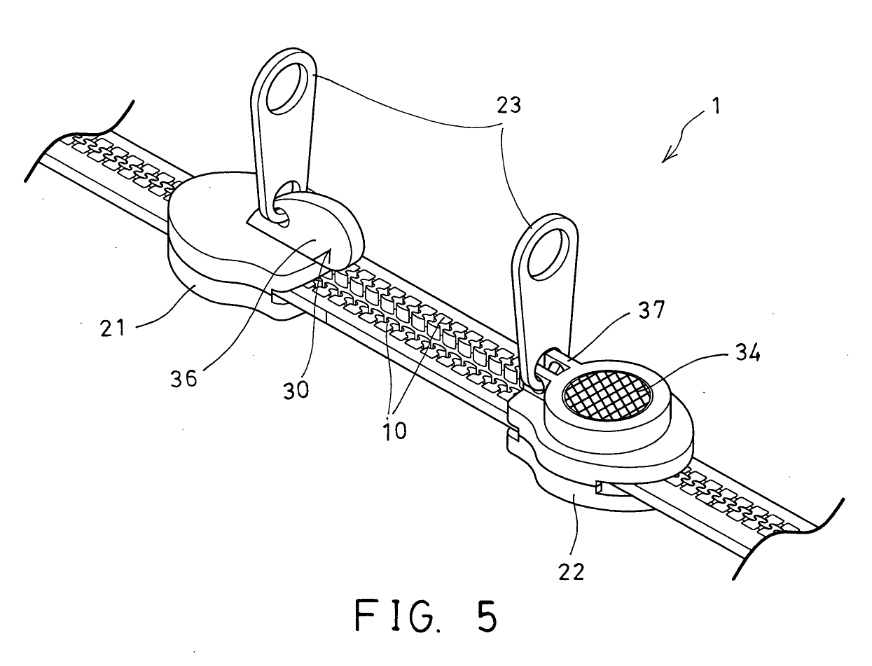

Referring to the drawings, and initially to FIGS. 1 and 2, a slide fastener device 1 in accordance with the present invention comprises two fastening elements 10, and one or more slider members 20 (FIGS. 1, 2), or 21, 22 (FIGS. 4, 5) slidably attached or engaged onto the fastening elements 10 for openably securing the fastening elements 10 together and for openably closing two side panels or housing members or support members 80 (FIGS. 1, 2) together, and the slider members 20-22 each may include a manual operating element or tab 23 for operating the slider members 20-22. The above-described structure is typical and will not be described in further details.

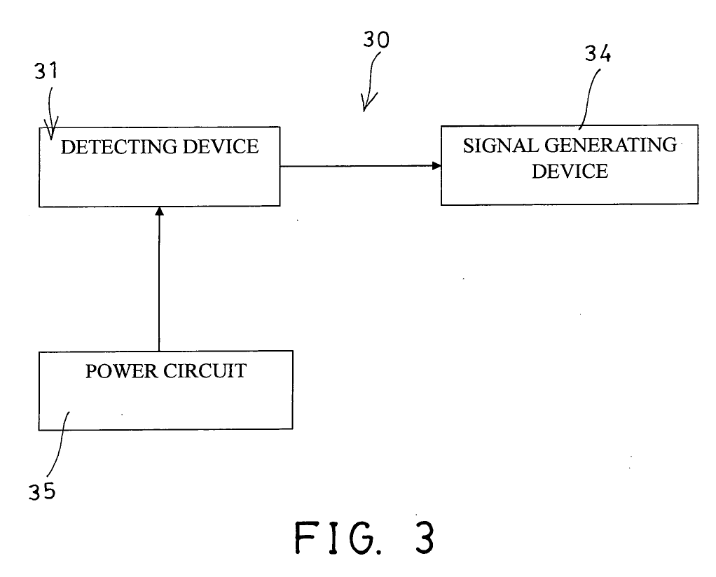

The slide fastener device 1 in accordance with the present invention further includes a warning device 30 for generating a warning light or sound signal and for indicating that the fastener device 1 has not been suitably locked or buckled in place and for preventing the fastener device 1 from being opened by unauthorized persons. For example, as shown in FIG. 3, the warning device 30 includes a sensing or detecting device 31 having a sensing or detecting member 32 (FIG. 1) attached to the tab 23 or the slider member 20, and another sensing or detecting member 33 (FIGS. 1, 2) attached to the support member 80 for electrically coupling or engaging with the detecting member 32 and for forming a close circuit.

A signal generating device 34, such as a light device or a buzzer 34 may be coupled to the detecting device 31 for generating a warning light or sound signal and for indicating that the fastener device 1 has not been suitably locked or buckled in place or the detecting members 31, 32 have not been suitably locked or contacted with each other, and the warning device 30 may include a power device or circuit 35, such as one or more batteries 35 coupled to the detecting device 31 for energizing the detecting device 31 and/or the signal generating device 34. Alternatively, as shown in FIGS. 4-5, the warning device 30 may include two sensing or detecting members 36, 37 attached to the slider members 21, 22 respectively and electrically contactable with each other (FIG. 4) for forming a close circuit, or separatable from each other (FIG. 5) for opening the circuit.

It is to be noted that the detecting members 31, 32, or 36, 37 may be selectively attached to the tab 23 or the slider member 20 and the support member 80; or selectively attached to the tab 23 or the slider members 21-22 respectively, and arranged for allowing the detecting members 31, 32, or 36, 37 to be selectively contacted with each other or to be selectively separated from each other in order to form the close circuit or the opened circuit, and so as to selectively indicate whether the fastener device 1 has not been suitably locked or buckled in place or not, or whether the detecting members 31, 32 have not been suitably locked or contacted with each other or not. One of the slider members 21-22 may be taken as a support member for supporting the other detecting members 36, 37.

Accordingly, the slide fastener device in accordance with the present invention includes a warning device for generating a warning signal and for indicating that the fastener device has not been suitably locked or buckled in place and for preventing the fastener device from being opened by unauthorized persons.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
two fastening elements,
a slider member slidably engaged onto said fastening elements for securing said fastening elements together, and
a warning device including a detecting device having a first detecting member attached to said slider member, and a second detecting member for selectively engaging with said first detecting member, and
a signal generating device coupled to said detecting device for generating a warning signal when said first and said second detecting members have not been contacted with each other.

2. The slide fastener device as claimed in claim 1, wherein said slider member includes a manual operating tab for operating said slider member, and either of said first or said second detecting member is attached to said tab.

3. The slide fastener device as claimed in claim 1, wherein either of said first or said second detecting member is attached to a support member.

4. The slide fastener device as claimed in claim 3, wherein said support member is another slider member.

5. The slide fastener device as claimed in claim 1, wherein said warning device includes a power circuit coupled to said detecting device.
